(19) United States
(12) Patent Application Publication
(10) Pub. No.: US 2023/0166418 A1
(43) Pub. Date: Jun. 1, 2023

(54) RAZOR CARTRIDGE

(71) Applicant: DORCO CO., LTD., Seoul (KR)

(72) Inventor: Se Min PARK, Seoul (KR)

(21) Appl. No.: 18/058,609

(22) Filed: Nov. 23, 2022

(30) Foreign Application Priority Data
Nov. 30, 2021 (KR) 10-2021-0168709

(51) Int. Cl. B26B 21/22

(52) U.S. Cl. CPC B26B 21/227

(57) ABSTRACT

Disclosed is a razor cartridge including: at least one razor blade including an edge portion with a cutting edge, a bent portion, and base portion; a blade housing configured to accommodate at least one razor blade in a longitudinal direction; and a lateral supporter spaced apart from a bottom of the blade housing, extended from an inner lateral wall of the blade housing, and configured to support a longitudinal lateral portion of the razor blade. The height of the bottom supporter supporting the center portion of the razor blade is lowered to lower the difficulty in manufacturing a mold for injection molding, the lateral supporter protrudes to stably support the edge of the razor blade, and the bottom supporter having a low height to further secure a cleaning passage in the center portion of the razor blade cartridge to thereby have an effect on more easily removing sludge.

### CROSS REFERENCE TO RELATED APPLICATION

This application claims the benefit of Korean Patent Application No. 10-2021-0168709 filed on Nov. 30, 2021, the contents of which are all hereby incorporated by reference herein in their entirety.

### BACKGROUND OF THE INVENTION

### Field of the Invention

The disclosure relates to a razor cartridge, and more particularly to a razor cartridge with a razor blade supporter provided in a blade housing.

### Description of the Related Art

In general, a wet razor includes a razor cartridge and a razor handle. The razor cartridge includes a blade housing formed with a guard and a cap, and a razor blade mounted inside the blade housing.

The razor cartridge is detachably provided in the razor handle. Thus, a user can remove the razor cartridge that has been used to some extent, and mount a new razor cartridge to the razor handle.

Meanwhile, shaving performance may be improved by mounting a plurality of razor blades to the blade housing. However, when the plurality of razor blades is mounted to a narrow blade housing, it may be difficult to clean the inside of the razor cartridge. Further, long razor blades may tremble or separate during shaving when they are not firmly supported at a plurality of positions. Accordingly, the razor cartridge is required to have a structure and shape for firmly supporting the razor blades and improving ease of cleaning.

### SUMMARY OF THE INVENTION

An aspect of the disclosure is to provide a razor cartridge, in which a razor blade supporter for supporting razor blades inside the razor cartridge has an improved structure to firmly support the razor blades installed in a blade housing, and space for discharging sludge is secured through the improved structure of the supporter to efficiently carry out cleaning.

According to an embodiment of the disclosure, there is provided a razor cartridge including: at least one razor blade including an edge portion with a cutting edge, a bent portion, and base portion; a blade housing configured to accommodate at least one razor blade in a longitudinal direction; and a lateral supporter spaced apart from a bottom of the blade housing, extended from an inner lateral wall of the blade housing, and configured to support a longitudinal lateral portion of the razor blade.

In the razor cartridge according to the disclosure, the height of the bottom supporter supporting the center portion of the razor blade is lowered to lower the difficulty in manufacturing a mold for injection molding, the lateral supporter protrudes to stably support the edge of the razor blade, and the bottom supporter having a low height to further secure a cleaning passage in the center portion of the razor blade cartridge to thereby have an effect on more easily removing sludge remaining in the razor blade cartridge.

### BRIEF DESCRIPTION OF THE DRAWINGS

FIG. 1 is a perspective view of a razor cartridge according to an embodiment of the disclosure.

FIG. 2 is an exploded perspective view of a razor cartridge according to an embodiment of the disclosure.

FIG. 3 is a plan view of a blade housing according to an embodiment of the disclosure.

FIG. 4 is a view showing a lateral supporter and a bottom supporter according to an embodiment of the disclosure.

FIG. 5 is a view showing a lateral supporter and a bottom supporter according to a second embodiment of the disclosure.

FIG. 6 is a view showing a lateral supporter and a bottom supporter according to a third embodiment of the disclosure.

FIG. 7 is a view showing a lateral supporter and a bottom supporter according to a fourth embodiment of the disclosure.

### DETAILED DESCRIPTION OF THE INVENTION

Hereinafter, embodiments of a razor cartridge according to the disclosure will be described. The disclosure is not limited to the embodiments set forth herein, but may be alternatively embodied in various forms. Rather, the embodiments described below are provided so that the disclosure can be thorough and complete and fully convey the scope of the disclosure to a person having ordinary knowledge in the art.

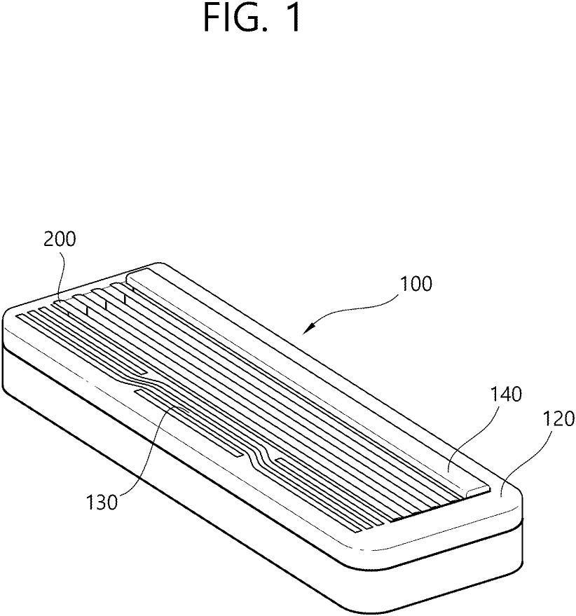

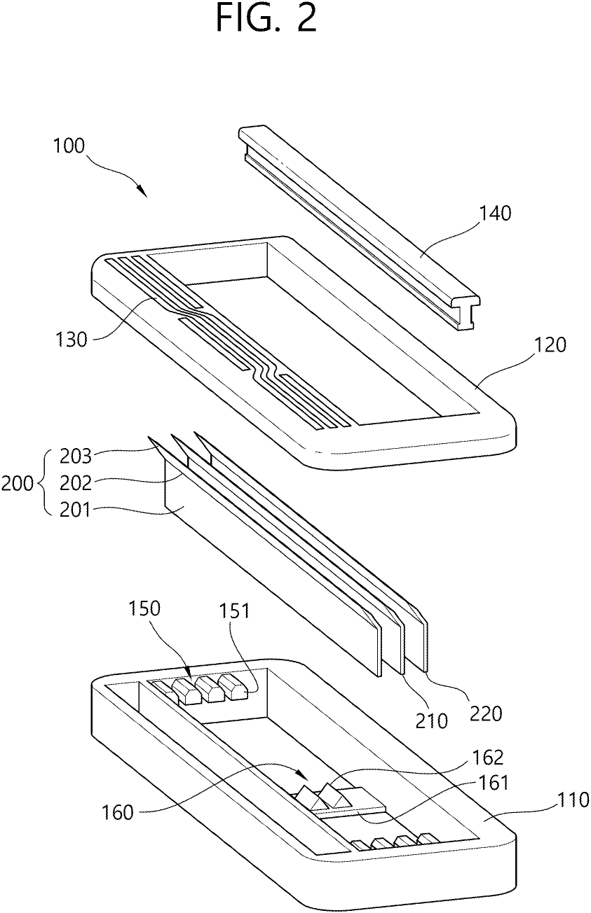

FIG. 1 is a perspective view of a razor cartridge 100 according to an embodiment of the disclosure, and FIG. 2 is an exploded perspective view of the razor cartridge 100 according to an embodiment of the disclosure.

Referring to FIGS. 1 and 2, the razor cartridge 100 according to an embodiment of the disclosure includes a blade housing 110 in which a plurality of razor blades 200, 210 and 220 are accommodated in a longitudinal direction. In the following description, the longitudinal direction will refer to the lengthwise direction of the blade housing 110, and a transverse direction will refer to a direction perpendicular to the longitudinal direction.

The razor cartridge 100 may be coupled to a handle (not shown) by a pivot connection structure. The handle may be manufactured to be separable from the razor cartridge 100 and reusable. Alternatively, the handle and the razor cartridge 100 may be formed as a single body.

The razor cartridge 100 may include the blade housing 110, a guard 130, a cap 120, and the razor blades 200, 210 and 220. The blade housing 110 may be provided with the guard 130 in front of the razor blades 200, 210 and 220, and the cap 120 in back of the razor blades 200, 210 and 220.

The guard 130 is to stand a user’s body hair up in a direction approximately perpendicular to a shaving direction so that the razor blades 200, 210 and 220 can easily cut the body hair. The guard 130 may be made of plastic or an elastic material.

The cap 120 provided opposite to the guard 130 may include a lubrication strip, and may serve to smooth a user’s skin from which the body hair is cut and reduce irritation applied to the skin during shaving.

The blade housing 110 may include an upper section 110a and a lower section 110b which are couplable to each other. The upper section may be coupled to the lower section 110b in the state that the razor blades 200, 210 and 220 are accommodated inside the lower section 110b, thereby allowing the longitudinal lateral portions of the upper section 110a to support the longitudinal lateral portions of the razor blades 200, 210 and 220. Thus, the razor blades 200, 210 and 220 are firmly supported in the blade housing 110.

Meanwhile, FIG. 2 illustrates that the blade housing 110 includes the upper section 110a and the lower section 110b, but the blade housing 110 according to an alternative embodiment may be provided as a single body. In this case, the razor blades 200, 210 and 220 may be firmly supported in the blade housing 110 through a pair of clips (not shown) respectively coupled to the longitudinal lateral portions of the blade housing 110.

The blade housing 110 accommodates a plurality of razor blades 200, 210 and 220 therein in the longitudinal direction.

According to an embodiment of the disclosure, the razor blade most adjacent to the guard 130 will be called a first razor blade 200, the razor blade adjacent to the first razor blade 200 will be called a second razor blade 210, and the razor blade adjacent to the second razor blade 210 will be called a third razor blade 220. However, the number of razor blades according to the disclosure is not limited to three, and the number of razor blade may be varied depending on embodiments.

Each of the razor blades 200, 210 and 220 includes a base portion 201 mounted and supported inside the blade housing 110, a bent portion 202 bent and extended from one end of the base portion 201, and an edge portion 203 extended from one end of the bent portion 202 and having a cutting edge to cut body hair.

The razor blades 200, 210 and 220 may be made of stainless steel, ceramic, and various other metallic or nonmetallic materials. The razor blades 200, 210 and 220 may be embodied in the form of an integrated razor blade formed by a bending process, a joined blade formed by joining the cutting-edge portion 203 to a bending position, etc.

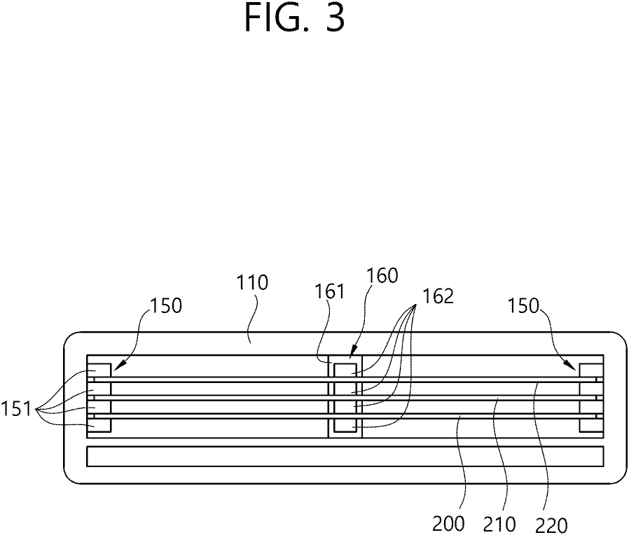

FIG. 3 is a plan view of the blade housing 110 according to an embodiment of the disclosure.

Referring to FIG. 3, the blade housing 110 includes a razor blade supporter 140 to support the razor blades 200, 210 and 220 accommodated therein.

The razor blade supporter 140 may include a lateral supporter 150 positioned at opposite inner ends of the blade housing 110 to support the longitudinal lateral portion of the razor blade, and a bottom supporter 160 formed at a central inner portion of the blade housing 110 to mount and support the base portion 201 of the razor blade.

The lateral supporter 150 may include a plurality of support arms 151, 153, 154 and 155 to support the longitudinal lateral portions of the razor blades 200, 210 and 220. The plurality of support arms 151, 153, 154 and 155 are spaced apart at a predetermined distance from the bottom of the blade housing 110, and extended from the inner lateral wall of the blade housing 110.

The plurality of support arms 151, 153, 154 and 155 may be disposed on the lateral wall of the blade housing 110 in the transverse direction. The number of support arms 151, 153, 154 and 155 may be varied depending on the number of razor blades 200, 210 and 220 accommodated in the blade housing 110.

The support arms 151, 153, 154 and 155 may be extended from an upper area on the lateral wall of the blade housing 110, but the disclosure is not limited to this feature. For example, the support arms 151, 153, 154 and 155 may be extended from a middle or lower area on the lateral wall of the blade housing 110.

Further, the support arms 151, 153, 154 and 155 may have predetermined rigidity to more firmly support the razor blades. To secure the rigidity sufficiently, the support arms 151 may be made of a rigid material, or may have predetermined thickness, width, length, etc. However, the disclosure is not limited to this feature, and the support arms 151 according to an embodiment may be elastically transformable within a predetermined range.

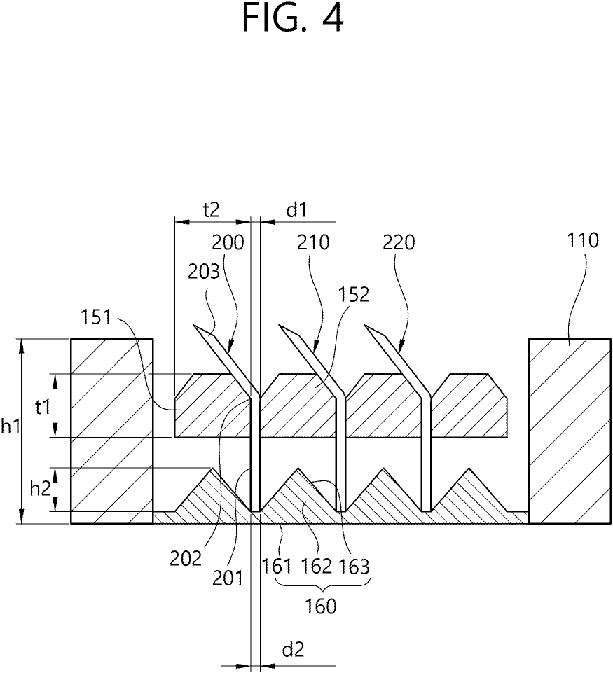

FIG. 4 is a view showing the lateral supporter 150 and the bottom supporter 160 according to an embodiment of the disclosure.

Referring to FIG. 4, each of the support arms 151, 153, 154 and 155 includes a contact surface 152 provided to come into contact with each bent portion 202 of the razor blades 200, 210 and 220. The contact surface 152 may be at least partially inclined. In each of the support arms 151, 153, 154 and 155, both upper ends in the transverse direction may be inclined in opposite directions.

The support arm 151 adjacent to the guard 130 supports a front surface of the bent portion 202 and a partial front surface of the base portion 201 of the first razor blade 200. The next support arm 153 supports a partial back surface of the base portion 201 of the first razor blade 200, and, on its opposite inclined surface, supports a front surface of the bent portion and a partial front surface of the base portion of the second razor blade 210. The next support arm 154 supports a partial back surface of the base portion of the second razor blade 210 and supports a front surface of the bent portion and a partial front surface of the base portion of the third razor blade 220. The last support arm 155 supports a partial back surface of the base portion of the third razor blade 220.

Therefore, a partial area of the base portion 201, for example, an upper area of the base portion 201 of the razor blade 200 may be supported between two support arms 152 and 153 adjacent to the corresponding razor blade 200, and the front surface of the bent portion 202 of each razor blade 200 may be supported on the inclined surface 152 of the support arm 151 adjacent to the front of the corresponding razor blade 200. In this case, the inclined surface 152 of the support arm 151 may support at least a partial area of the edge portion 203 of the razor blade 200.

Meanwhile, FIG. 4 illustrates that the inclined surface 152 of the support arm is flat, but the disclosure is not limited to this feature. For example, the inclined surface of the support arm may include a curved area to correspond to the shape of the bent portion.

According to an embodiment of the disclosure, each support arm may have a thickness t1 of 0.7 to 1.6 mm in upper and down directions. Further, the thickness t1 of the support arm in the up and down directions may be sufficient to at least support a partial area of the bent portion of the razor blade, and furthermore to additionally support a partial area of the base portion or half the base portion of the razor blade. When the thickness t1 of the support arm in the up and down directions ranges from 0.7 to 1.6 mm, the support arm can have high durability, and secure enough space between the support arms and the bottom supporter 160 to thereby improve ease of cleaning.

Further, each support arm may have a thickness t2 of 0.8 to 1.4 mm in a transverse direction. Further, the thickness t2 of the support arm in the transverse direction may be greater than or equal to a transverse distance between the cutting edge of the edge portion and the base portion of the razor blade, and lower than or equal to the maximum span of the razor blade. When the thickness t2 of the support arm in the transverse direction ranges from 0.8 to 1.4 mm, an optimum span is provided between the razor blades, thereby satisfying both the shaving performance and the ease of cleaning.

A transverse distance d1 between the support arms may range from 0.08 to 0.15 mm, or may be greater than or equal to the thickness of the razor blade. Thus, the support arms can more firmly hold the razor blades, thereby minimizing the trembling of the razor blade during shaving.

The bottom supporter 160 is formed on a bottom center portion of the blade housing 110 of the razor cartridge 100. Further, the lateral supporter 150 and the bottom supporter 160 may support the razor blade at different heights. The lateral supporter 150 may support a portion of the base portion 201 and the bent portion 202 of the razor blade 200. When the plurality of razor blades 200, 210 and 220 is supported at the different heights, the razor blades 200, 210 and 220 are supported more firmly, thereby minimizing the trembling of the razor blade and preventing the razor blades 200, 210 and 220 from separating during shaving. In addition, space is further secured as much as the height difference between the lateral supporter 150 and the bottom supporter 160, so that sludge can be effectively discharged during cleaning, thereby improving ease of cleaning.

Alternatively, the lateral supporter 150 and the bottom supporter 160 may support the base portion 201 of the razor blade at partially overlapping heights.

A vertical height h1 from the bottom of the bottom supporter 160 to the top of the lateral supporter 150 may range from 2.5 to 2.7 mm. When the lateral supporter 150 has the vertical height h1 of 2.5 to 2.7 mm, space between the lateral supporter 150 and the bottom supporter 160 becomes wider, and thus ease of cleaning is further improved.

The bottom supporter 160 may include a bottom support 161 extended in the transverse direction of the blade housing 110, and a plurality of mounting protrusions 162 protruding from an upper portion of the bottom support 161 and arranged along the transverse direction of the bottom support 161. The base portions 201 of the razor blades 200, 210 and 220 may be supported by the mounting protrusions 162. Further, the top of the mounting protrusion 162 may be positioned below the bottom of the support arm 151 of the lateral supporter 150.

According to an embodiment of the disclosure, the mounting protrusion 162 of the bottom supporter 160 may protrude upward from the surface of the bottom support 161 at a height h2 of 0.5 to 2.7 mm. Alternatively, the mounting protrusion 162 may be formed to have the minimum height from the bottom of the bottom support 161 up to about 20% of each base portion 201 of the razor blades 200, 210 and 220, and the maximum height up to the cutting-edge portion of the razor blade. When the height h2 of the mounting protrusion 162 ranges from 0.5 to 2.7 mm, space between the lateral supporter 150 and the bottom supporter 160 becomes wider while the base portion of the razor blade is sufficiently supported, thereby improving the ease of cleaning.

Further, a transverse distance d2 between the mounting protrusions may range from 0.08 to 0.15 mm, and may be greater than or equal to the thickness of the razor blade. Further, the transverse distance d2 between the mounting protrusions may be greater than or equal to the distance d1 between the support arms because the support arms of the lateral supporter 150 firmly hold the razor blade. When the transverse distance d2 between the mounting protrusions is greater than the distance d1 between the support arms, space is further secured around the base portion of the razor blade, thereby improving the ease of cleaning.

Both sides of the mounting protrusion 162 in the transverse direction may be inclined in opposite directions. Therefore, the cross-section of the mounting protrusion 162 may be approximately shaped like an isosceles triangle. An inclined surface 163 of the mounting protrusion 162 guides the base portion 201 of the razor blade to be in position when the razor blades 200, 210 and 220 are installed, so that the razor blades can be more easily arranged. Further, the mounting protrusion 162 having a low height may facilitate the removal of sludge when the razor cartridge 100 is cleaned.

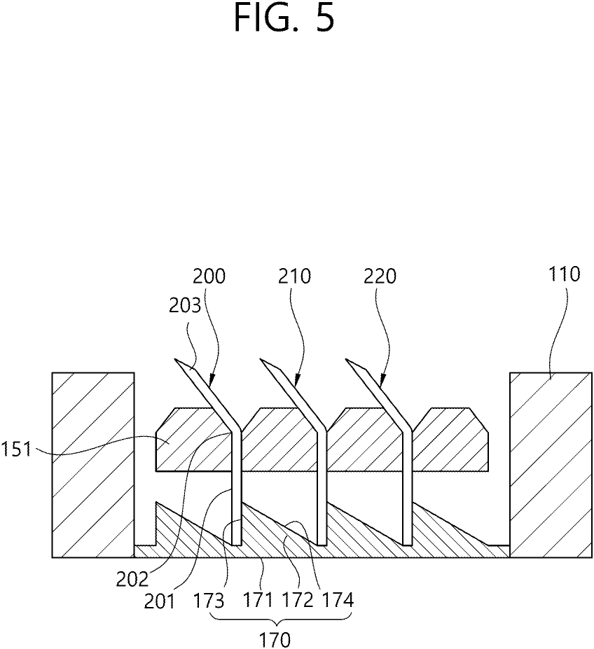

FIG. 5 is a view showing a lateral supporter 150 and a bottom supporter 170 according to a second embodiment of the disclosure.

Referring to FIG. 5, the lateral supporter 150 includes support arms 151, 153, 154 and 155 spaced apart at a predetermined distance from the bottom of the blade housing 110. The support arms 151, 153, 154 and 155 are extended from the inner lateral wall of the blade housing 110 and support the longitudinal lateral portions of the razor blades 200, 210 and 220. In this embodiment, the lateral supporter 150 may refer to that of the foregoing embodiment of the disclosure.

The bottom supporter 170 includes a bottom support 171 extended in the transverse direction of the blade housing 110, and a plurality of mounting protrusions 172 protruding from the bottom support 171. The side of the mounting protrusion 172 facing toward the front of the blade housing 110 may form a vertical surface 173, and the mounting protrusion 172 may be approximately shaped like a right-angled triangle. The vertical surface 173 may support the back surface of the base portion 201 of the razor blade.

The vertical surface 173 of the mounting protrusion 172 may stably support each base portion 201 of the razor blades 200, 210 and 220 against force acting backward on the razor blades 200, 210 and 220 during shaving. Further, space formed by an inclined surface 174 of the front mounting protrusion 172 in front of the vertical surface 173 guides each base portion 201 of the razor blades 200, 210 and 220 to be in position when the razor blades 200, 210 and 220 are installed, so that the razor blades can be more easily arranged. Further, the mounting protrusion 172 having a low height may facilitate the removal of sludge when the razor cartridge 100 is cleaned.

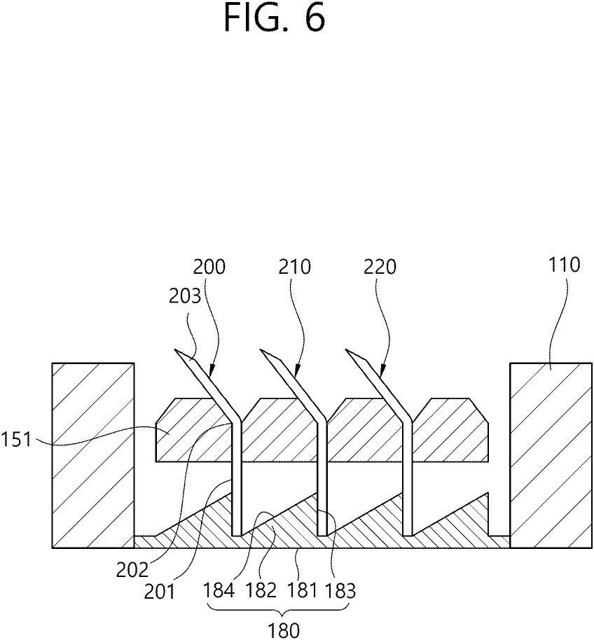

FIG. 6 is a view showing a lateral supporter 150 and a bottom supporter 180 according to a third embodiment of the disclosure.

Referring to FIG. 6, the lateral supporter 150 includes a plurality of support arms 151, 153, 154 and 155 spaced apart at a predetermined distance from the bottom of the blade housing 110. The plurality of support arms 151, 153, 154 and 155 are extended from the inner lateral wall of the blade housing 110 and support the longitudinal lateral portions of the razor blades 200, 210 and 220. In this embodiment, the lateral supporter 150 may refer to those of the foregoing embodiments of the disclosure.

The bottom supporter 180 includes a bottom support 181 extended in the transverse direction of the blade housing 110, and a plurality of mounting protrusions 182 protruding from the bottom support 181. The side of the mounting protrusions 182 facing toward the back of the blade housing 110 may form a vertical surface 183, and the mounting protrusions 182 may be approximately shaped like a right-angled triangle. The vertical surface 183 may support the front surface of each base portion of the razor blades 200, 210 and 220.

The vertical surface 183 supports the front surface of the base portion 201 during shaving, thereby preventing the razor blades 200, 210 and 220 from lying down toward the cap 120 by force acting on a cutting-edge portion 203 of the razor blade during the shaving. Further, space formed by an inclined surface 184 of the mounting protrusion 182 in front of the vertical surface 183 guides each base portion 201 of the razor blades 200, 210 and 220 to be in position when the razor blades 200, 210 and 220 are installed, so that the razor blades can be more easily arranged. Further, sludge is easily removed when the razor cartridge 100 is cleaned.

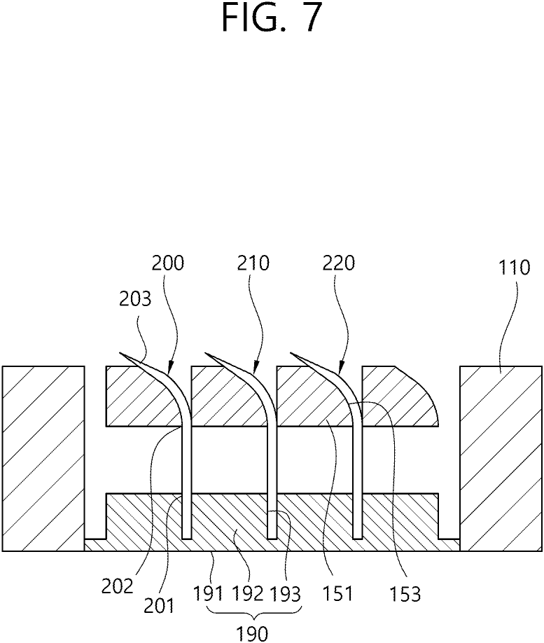

FIG. 7 is a view showing a lateral supporter 150 and a bottom supporter 190 according to a fourth embodiment of the disclosure.

Referring to FIG. 7, the lateral supporter 150 includes a plurality of support arms 151, 153, 154 and 155 spaced apart at a predetermined distance from the bottom and protruding from the inner lateral wall of the blade housing 110. The plurality of support arms 151, 153, 154 and 155 are extended from the inner lateral wall of the blade housing 110 and support the longitudinal lateral portion of the razor blades 200, 210 and 220. In this embodiment, the lateral supporter 150 may refer to those of the foregoing embodiments of the disclosure.

The bottom of the support arms 151 facing toward the bottom supporter 160 and the front surface of the support arm 151 facing toward the guard 130 are respectively formed on planes orthogonal to each other. Further, the support arm 151 has a curved surface 156 in an upper portion thereof having a predetermined curvature. The curved surface 156 of the support arm 151 may support a partial or entire area of a cutting-edge portion 203 and the bent portion of the razor blade. In this case, the curved surface 156 may partially support an upper area of the base portion 201.

According to the fourth embodiment of the disclosure, the edge portions 203 and the bent portions 202 of the razor blades 200, 210 and 220 are supported being in close contact with the curved surface 156. Thus, the trembling of the razor blades 200, 210 and 220 is minimized to thereby improve a shaving efficiency.

On the bottom of the blade housing 110, a bottom supporter 190 is provided. The bottom supporter 190 includes a bottom support 191 extended from a bottom center portion of the blade housing 110 in the transverse direction, and a plurality of mounting protrusions 192 protruding from the bottom support 191 and spaced apart from each other having quadrangular shapes. The plurality of mounting protrusions 192 may be arranged on the bottom support 191 in the transverse direction. Further, the lateral side of the mounting protrusion 192 in the transverse direction forms a vertical surface 193 to support the base portion 201 of the razor blade 200 through surface contact.

Meanwhile, according to an alternative embodiment, the mounting protrusion of the bottom supporter may have a polygonal shape, a hemispherical shape, etc.

The shapes of the lateral supporter and the bottom supporter according to the foregoing embodiments of the disclosure may be exchanged each other, and not limited to the embodiments shown in the accompanying drawings. Further, the thickness and size of the support arms and the mounting protrusions, and the position of the support arms and the mounting protrusions formed inside the blade housing may be variously modified without departing from the technical scope of the disclosure.

Although few embodiments of the disclosure have been described based on the embodiments illustrated in the accompanying drawings and detailed description, such embodiments are merely examples, and various changes and equivalents can be made by a person having ordinary knowledge in the art to which the disclosure pertains. Accordingly, the technical scope of the disclosure will be defined in the appended claims.

What is claimed is:

1. A razor cartridge comprising:
at least one razor blade comprising an edge portion with a cutting edge, a bent portion, and base portion;
a blade housing configured to accommodate at least one razor blade in a longitudinal direction; and
a lateral supporter spaced apart from a bottom of the blade housing, extended from an inner lateral wall of the blade housing, and configured to support a longitudinal lateral portion of the razor blade.

2. The razor cartridge of claim 1, wherein the lateral supporter comprises a contact surface configured to come into contact with the bent portion, and the contact surface is at least partially inclined.

3. The razor cartridge of claim 2, wherein
the razor blade comprises a first razor blade and a second razor blade adjacently accommodated in the blade housing in a longitudinal direction, and
the lateral supporter is configured to support a front surface of the first razor blade and a back surface of the second razor blade.

4. The razor cartridge of claim 1, further comprising a bottom supporter extended from the bottom of the blade housing and supporting the base portion of the razor blade.

5. The razor cartridge of claim 4, wherein the lateral supporter and the bottom supporter are configured to support the razor blade at different heights.

6. The razor cartridge of claim 4, wherein the lateral supporter and the bottom supporter are configured to support the razor blade at partially overlapping heights.

7. The razor cartridge of claim 4, wherein
the bottom supporter comprises mounting protrusions arranged in a transverse direction,
the mounting protrusion is configured to support the base portion of the razor blade.

8. The razor cartridge of claim 7, wherein at least one of opposite sides of the mounting protrusion in the transverse direction comprises an inclined surface.

9. The razor cartridge of claim 7, wherein at least one of opposite sides of the mounting protrusion in the transverse direction comprises a vertical surface configured to support a back surface or a front surface of the razor blade.

10. The razor cartridge of claim 7, wherein a protrusion height of the mounting protrusion ranges from 0.5 to 2.7 mm.

11. The razor cartridge of claim 7, wherein a transverse distance between two adjacent mounting protrusions among the mounting protrusion ranges from 0.08 to 0.15 mm.

12. The razor cartridge of claim 1, wherein the lateral supporter comprises a plurality of support arms.

13. The razor cartridge of claim 12, wherein a thickness of the support arm in up and down directions ranges from 0.7 to 1.6 mm.

14. The razor cartridge of claim 12, wherein a transverse width of the support arm ranges from 0.8 to 1.4 mm.

15. The razor cartridge of claim 12, wherein the plurality of support arms protrude at intervals of 0.08 to 0.15 mm.

16. The razor cartridge of claim 1, wherein a vertical height from a bottom of the bottom supporter to a top of the lateral supporter ranges from 2.5 to 2.7 mm.
